(19) United States
(12) Patent Application Publication
(10) Pub. No.: US 2007/0049361 A1
(43) Pub. Date: Mar. 1, 2007

(54) Side mounted wireless headset

(76) Inventors: Paul S. Coote, Niagra on the Lake (CA); Atin Patel, Mississauga (CA); Gora Ganguli, Burlington (CA); Kamal Ali, Oakville (CA); Randall Mileski, Burlington (CA)

Correspondence Address: STEPHEN D. SCANLON, JONES DAY, 901 LAKESIDE AVENUE, CLEVELAND, OH, 44114, US

(21) Appl. No.: 11/212,296

(22) Filed: Aug. 26, 2005

(51) Int. Cl. H04M 1/00

(52) U.S. Cl. 455/575.2

(57) ABSTRACT

In accordance with the teachings described herein, a side mounted wireless headset is provided. The wireless headset may be configured to communicate with a remote device over a short range wireless link. The wireless headset may include an eartip extending from a headset body that is configured to be inserted into an ear canal when the wireless headset is positioned on a user's head. The eartip, when inserted into the ear canal, may occlude the ear canal and secure the wireless headset to the user's head. An earhook may be attached to the headset body and may be configured to extend around an outer surface of the user's ear to further secure the wireless headset to the user's head.

### FIELD

The technology described in this patent document relates generally to the field of communication headsets. More particularly, the patent document describes a side mounted wireless headset, which is particularly well-suited for use as a wireless headset for communicating with a cellular telephone.

### BACKGROUND AND SUMMARY

Wireless headsets are used to wirelessly connect to a user's cell phone thereby enabling hands-free use of a cell-phone. The wireless link can be established using a variety of technologies, such as the Bluetooth short range wireless technology. One example of a wireless headset is set forth in commonly-owned U.S. patent application Ser. No. 10/961,762, entitled “Communication Headset with Signal Processing Capability,” the entirety of which is incorporated herein by reference.

In accordance with the teachings described herein, a side mounted wireless headset is provided. The wireless headset may be configured to communicate with a remote device over a short range wireless link. The wireless headset may include an eartip extending from a headset body that is configured to be inserted into an ear canal when the wireless headset is positioned on a user's head. The eartip, when inserted into the ear canal, may occlude the ear canal and secure the wireless headset to the user's head. An earhook may be attached to the headset body and may be configured to extend around an outer surface of the user's ear to further secure the wireless headset to the user's head.

### BRIEF DESCRIPTION OF THE DRAWINGS

FIG. 1 depicts a first side view of an example side mounted wireless headset.

FIG. 2 depicts a second side view of the example side mounted wireless headset.

FIG. 3 depicts a bottom view of the example side mounted wireless headset.

FIG. 4 is a top view of the example side mounted wireless headset.

FIGS. 5 and 6 depict two additional example eartips which may be attached to the side mounted wireless headset.

FIG. 7 depicts an example of a side mounted wireless headset that is mounted on a user ear.

### DETAILED DESCRIPTION

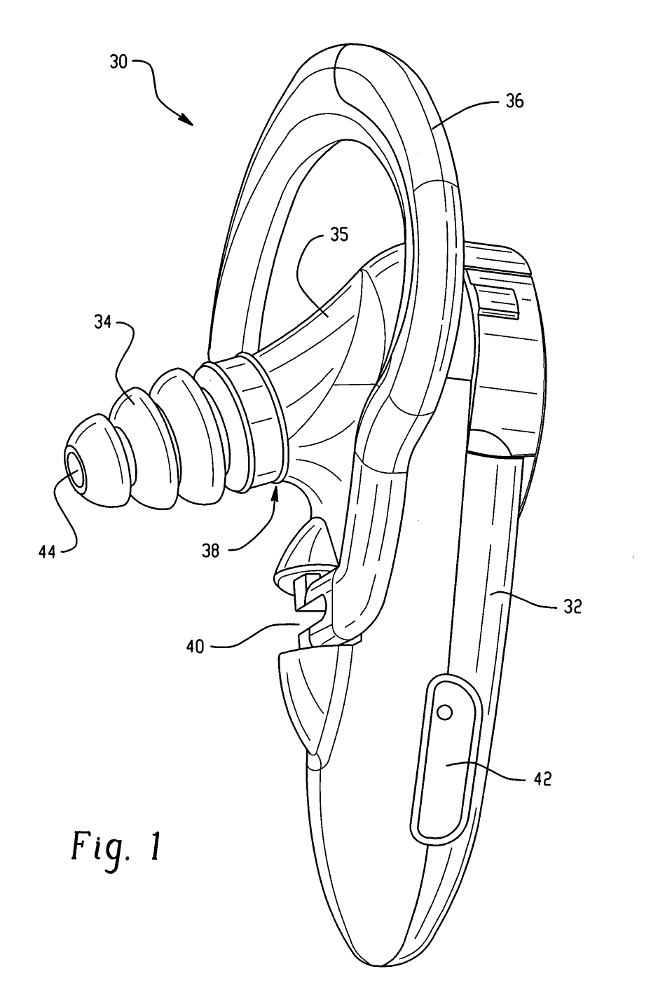

FIG. 1 depicts a first side view 30 of an example side mounted wireless headset. The headset includes a headset body 32, an eartip 34 that extends from the rear of the headset body 32, and an earhook 36 that is pivotally attached to the rear of the headset body 32. The headset body 32 includes wireless communication circuitry that provides a wireless link (e.g., a Bluetooth link) with a remote device, such as a cellular telephone, PDA, radio, MP3 player, CD player, portable game machine, etc. Audio signals received from the remote device are transmitted via an opening 44 in the eartip 34, which is configured to be inserted into a user's ear canal.

The headset body 32 includes a protruded portion 35 for connecting the eartip 34 to the headset body 32. The connection 38 between the eartip 34 and the protruded portion 35 of the headset body 32 may be by means of a pivotal connection, such as a ball and socket joint, that allows the eartip 34 to swivel for better positioning within the ear canal. In order to provide a secure and comfortable fit in the user's ear canal, the eartip 34 may be detached from the headset body 32 and replaced with an eartip that better matches the user's ear. Preferably, hearing aid eartips may be used, which are designed to be comfortably worn for long periods of time. When the headset 30 is in position, the eartip 34 provides the primary means for securing the headset 30 to the user's head. In addition, because the user's ear canal is occluded by the eartip 34, background noise may be reduced and sound quality improved.

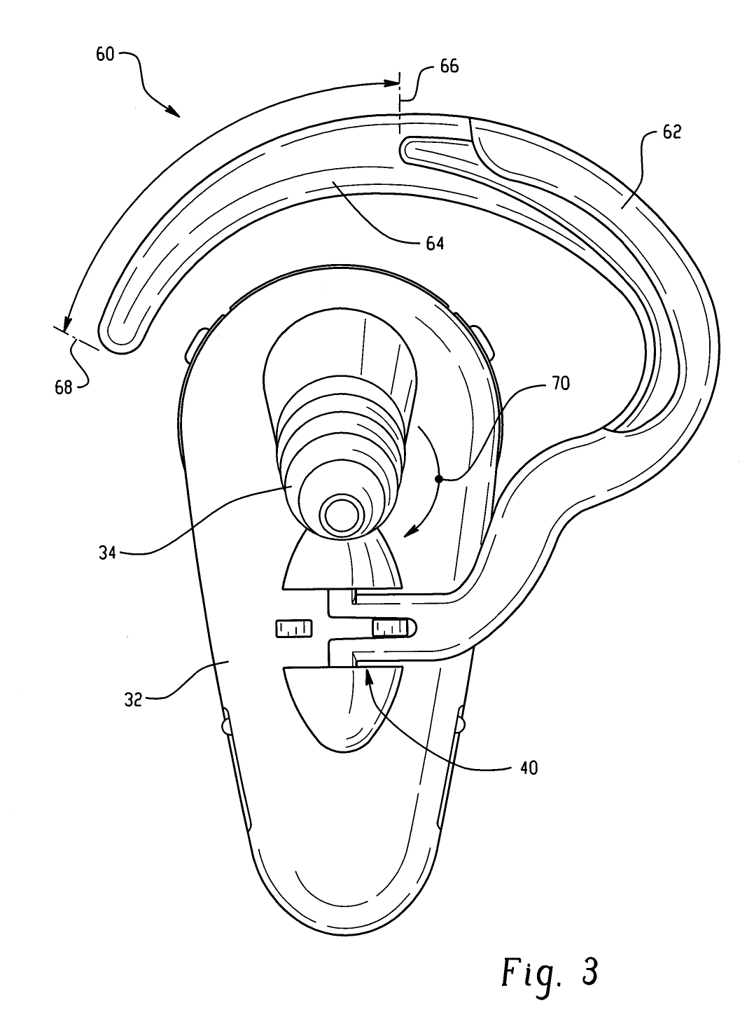

The headset is further secured by positioning the earhook 36 around the exterior of the user's ear. The earhook 36 may expand and contract at one or more positions along its length (see, e.g., FIG. 3) to provide a secure and comfortable fit around the user's ear. In another example, the earhook 36 may be made of a flexible material that conforms to the shape of the user's outer ear surface, or may be otherwise designed to provide a fit that may be customized to a particular user. In addition, the earhook 36 is attached to the headset body 32 with a hinge 40 that allows the earhook 36 to be rotated 180° so that the headset may be secured to either the left or right ear.

Also illustrated in FIG. 1 is a button 42 attached to the headset body 32, which may be used to provide a user input to circuitry within the headset. One or more buttons 42 may, for example, be used change operational modes, turn the device on or off, or for other purposes.

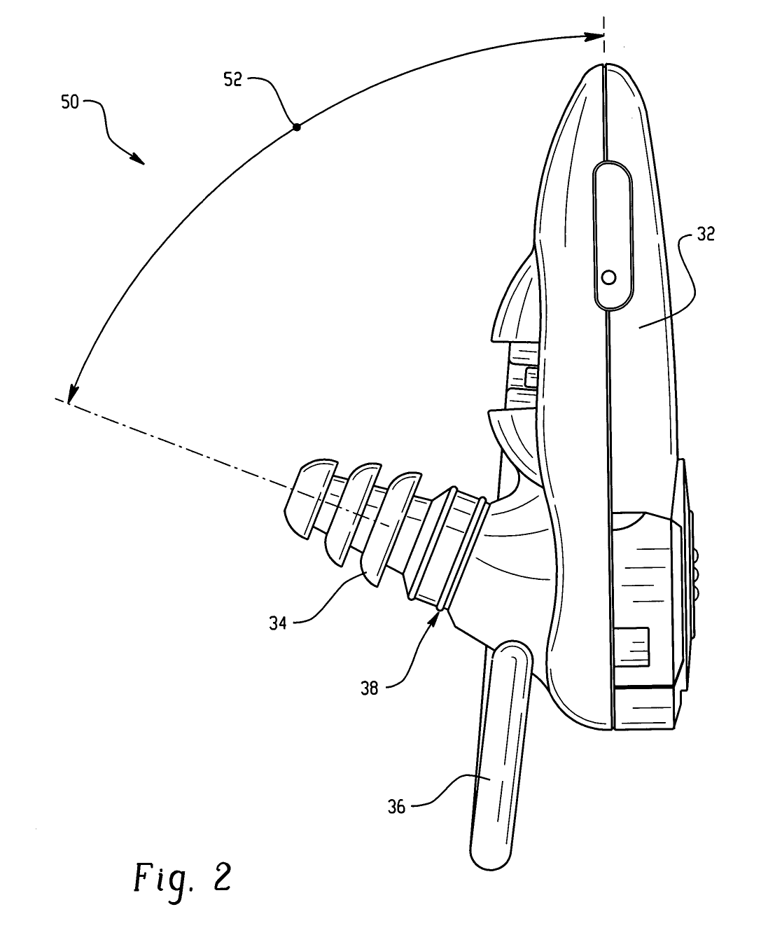

FIG. 2 depicts a second side view 50 of the example side mounted wireless headset. This view 50 depicts the headset from the opposite side as shown in FIG. 1. FIG. 2 illustrates that the eartip 34 extends at an acute angle 52 from the headset body 32. It has been determined that positioning the eartip 34 at an acute angle with respect to the headset body 32 provides improved comfort and a more secure fit than an eartip that extends at a right angle from the headset body. The preferred angle between the eartip 34 and the headset body 32 is dependent on the shape of the headset and particularly the shape and size of the earhook 36. In one example, the angle 52 between the eartip 34 and the headset body 32 is in the range of about 65° to about 75°.

FIGS. 3 depicts a bottom view 60 of the example side mounted wireless headset. FIG. 3 illustrates examples of how the eartip 34 and earhook 62 may be adapted to improve the fit for a particular user. The earhook 62 depicted in FIG. 3 includes an extendable portion 64 that may be adjusted between a first position 66 and a second position 68 to vary the overall length of the earhook 62. In this manner, the user may slide the extendable portion 64 of the earhook 62 in or out to adjust the earhook 62 to fit more securely and comfortably over the ear. In other examples the earhook 62 may be adjustable at more than one point along its length.

FIG. 3 also illustrates the rotational movement 70 of the eartip 34 with respect to the headset body 32. As described above, the eartip 34 may be rotated, for example on a ball and socket joint, to better secure the eartip 34 within the ear canal and to provide a more comfortable fit.

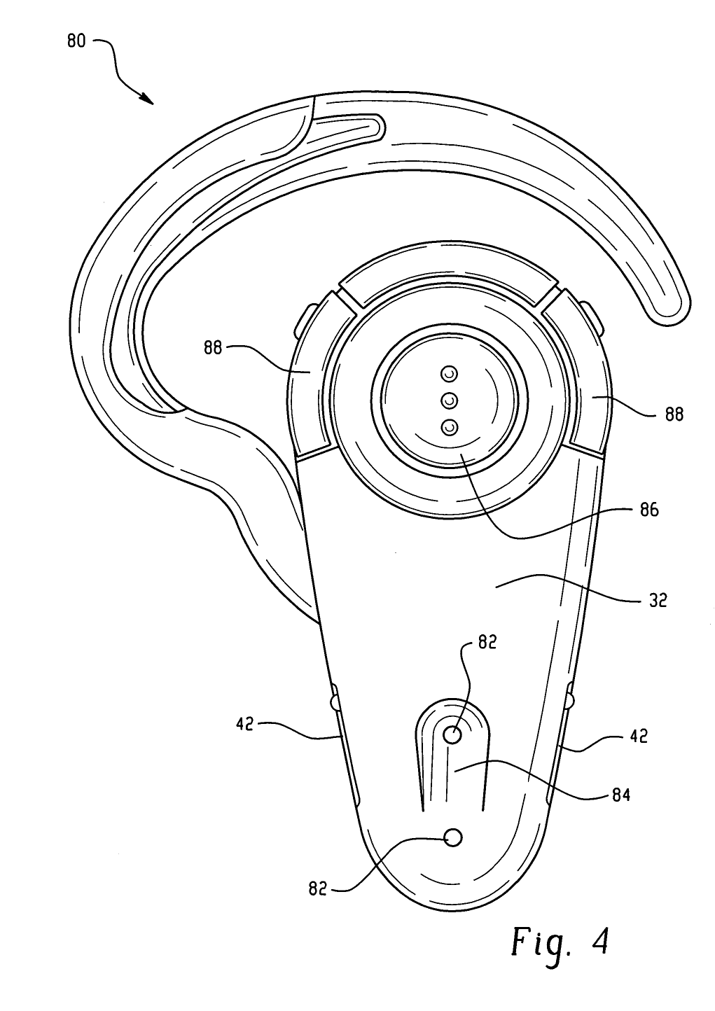

FIG. 4 is a top view 80 of the example side mounted wireless headset. This view 80 shows directional microphones 82 that are mounted within a recessed portion 84 of the headset body 32 The illustrated example includes two microphones, however other examples may include a different number of microphones, such as a single microphone or a microphone array having more than two microphones. The microphones 82 provide a directional microphone response that is configured to receive a clear audio signal from the user's voice and to minimize background noise. The recess 84 may be shaped to enhance the microphones' directionality by directing sound from the direction of the user's mouth towards the microphones and blocking sound from other directions. One example of a directional microphone array that may be used with the wireless headset described herein is set forth in commonly owned U.S. patent application Ser. No. 10/383,141, entitled “Low-Noise Directional Microphone System,” the entirety of which is incorporated herein by reference.

Also illustrated in FIG. 4 are input devices 42, 86 and 88, which may be used to provide a user input to circuitry within the headset. Input devices 88 may, for example, be used to adjust the headset volume, with one input device 88 being used to increase the headset volume and the other input device 88 being used to decrease the volume.

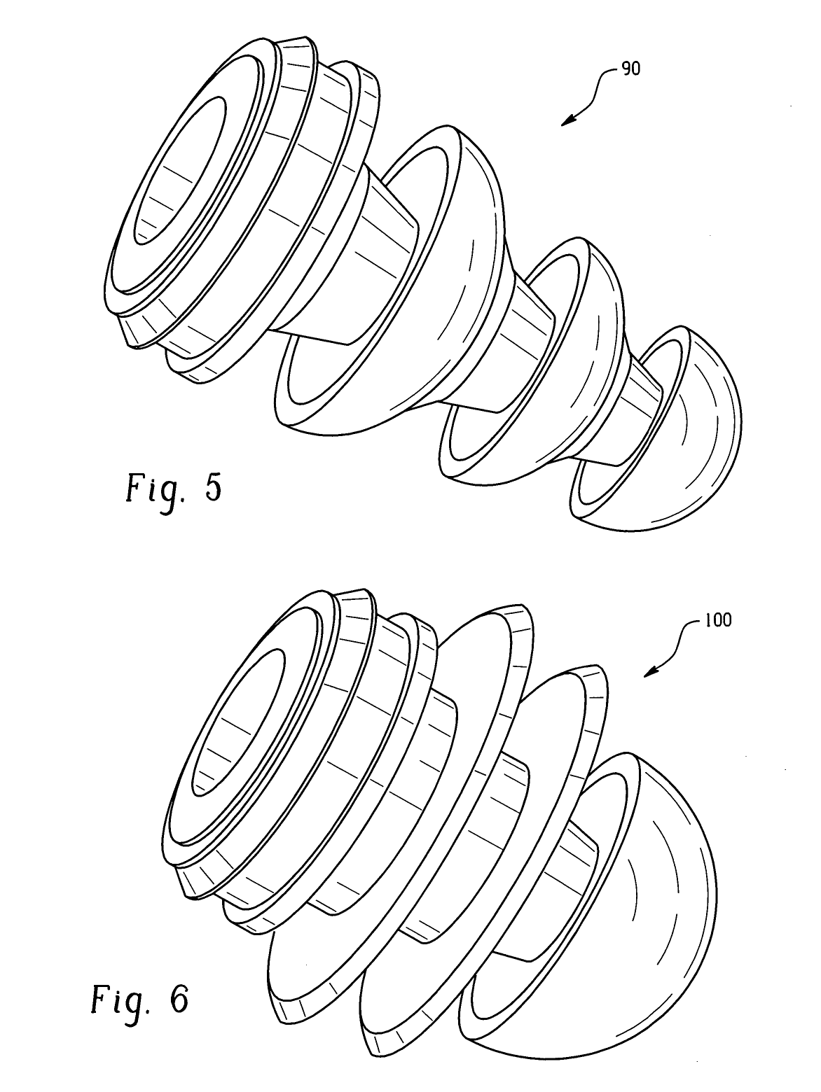

FIGS. 5 and 6 depict two additional example eartips 90, 100 which may be attached to the side mounted wireless headset. As described above, the eartip may be detached from the headset body 32 and replaced with an eartip that better matches the user's ear. The example eartips 90, 100 shown in FIGS. 5 and 6 depict two differently sized eartips. As illustrated, the size of the eartips may be varied, for example, by changing the size and/or shape of the flanges and also by changing the distance between flanges. In one example, three eartips sizes may be provided for the headset: a small eartip to fit 7 mm to 11 mm ear canal sizes, a medium eartip to fit 10 mm to 12 mm ear canal sizes, and a large eartip to fit 12 mm to 16 mm ear canal sizes. FIG. 5 depicts an example of a small eartip, FIG. 6 depicts an example of a large eartip, and FIG. 1 depicts an example of a medium eartip.

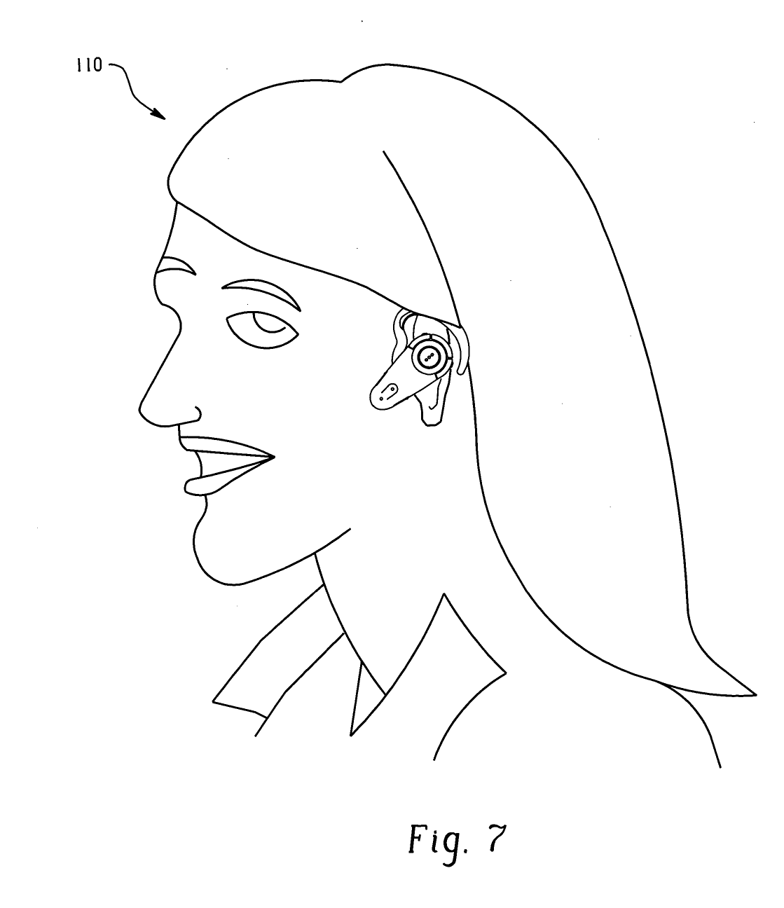

FIG. 7 depicts an example of a side mounted wireless headset that is mounted on a user ear.

This written description uses examples to disclose the invention, including the best mode, and also to enable a person skilled in the art to make and use the invention. The patentable scope of the invention may include other examples that occur to those skilled in the art. For instance, in one example the headset may be limited to receiving audio signals (e.g., from an MP3 player, CD player, etc.) and may therefore not include microphones.

It is claimed:

1. A wireless headset configured to communicate with a remote device over a short range wireless link, comprising:
a headset body;
an eartip extending from the headset body and configured to be inserted into an ear canal when the wireless headset is positioned on a user's head;
the eartip, when inserted into the ear canal, occluding the ear canal and securing the wireless headset to the user's head; and
an earhook attached to the headset body and configured to extend around an outer surface of the user's ear to further secure the wireless headset to the user's head.

2. The wireless headset of claim 1, wherein the eartip extends at an acute angle from the headset body.

3. The wireless headset of claim 2, wherein the acute angle is in the range of about 65° to about 75°.

4. The wireless headset of claim 1, wherein the eartip is the primary means for securing the wireless headset to the user's head.

5. The wireless headset of claim 1, wherein the eartip is attached to a protruded portion of the headset body.

6. The wireless headset of claim 5, wherein the eartip is pivotally connected to the protruded portion such that the eartip may be rotated with respect to the headset body in order to reposition the eartip within the ear canal.

7. The wireless headset of claim 1, wherein the eartip is detachable from the headset body, and wherein the eartip may be replaced by one or more differently sized eartips.

8. The wireless headset of claim 7, wherein the differently sized eartips include one or more of a small eartip that is configured to occlude ear canals having openings in a range of about 7 mm to about 11 mm, a medium eartip that is configured to occlude ear canals having openings in a range of about 10 mm to about 12 mm, and a large eartip that is configured to occlude ear canals having openings in a range of about 12 mm to about 16 mm.

9. The wireless headset of claim 1, wherein the earhook is attached to the headset body with a hinge, and wherein the earhook may be rotated on the hinge to secure the wireless headset to either a user' left or right ear.

10. The wireless headset of claim 1, wherein the earhook includes an extendable portion that is adjustable to vary an overall length of the earhook.

11. The wireless headset of claim 1, wherein the earhook includes a plurality of extendable portions that are adjustable to vary an overall length of the earhook.

12. The wireless headset of claim 1, wherein the earhook is manufactured of a flexible material that conformation to the outer surface of the user's ear.

13. The wireless headset of claim 1, wherein the wireless headset is configured for wireless communication with a cellular telephone.

14. The wireless headset of claim 1, wherein the wireless headset is configured for wireless communication with an MP3 player.

15. The wireless headset of claim 1, further comprising:
communications circuitry mounted within the headset body for communicating with the remote device over the short range wireless link.

16. The wireless headset of claim 15, wherein the communications circuitry utilizes Bluetooth wireless technology.

17. The wireless headset of claim 1, further comprising:
one or more directional microphones configured to receive an audio signal from the user's voice when the wireless headset is secured to the user's head.

18. The wireless headset of claim 17, wherein the one or more directional microphones are mounted within a recess in the headset body, the recess being shaped to direct the audio signal from the user's voice towards the one or more directional microphones.

19. The wireless headset of claim 1, further comprising:
one or more input devices mounted to the headset body and configured to receive input from the headset user.

20. The wireless headset of claim 19, wherein the one or more input devices include a first input device for increasing a volume of an audio signal transmitted into the ear canal via the eartip, and a second input device for decreasing the volume of the audio signal transmitted into the ear canal via the eartip.

21. The wireless headset of claim 19, wherein the one or more input devices include an input device for changing an operational mode of the wireless headset.

22. A wireless headset configured to communicate wirelessly with a remote device, comprising:
a headset body;
a first headset portion extending from the headset body and configured to secure the headset body to a user's head, the first headset portion occluding an ear canal of the user when the headset body is secured to the user's head; and
a second headset portion extending from the headset body and configured to further secure the headset body to the user's head.

23. The wireless headset of claim 22, wherein the second headset portion is configured to extend around an outer surface of the user's ear.

24. A cellular communications system, comprising:
a cellular telephone; and
a wireless headset configured to communicate with the cellular telephone over a wireless link, the wireless headset including:
a headset body;
a first headset portion extending from the headset body and configured to secure the headset body to a user's head, the first headset portion occluding an ear canal of the user when the headset body is secured to the user's head; and
a second headset portion extending from the headset body and configured to further secure the headset body to the user's head.
